(19) United States
(12) Patent Application Publication
(10) Pub. No.: US 2022/0024251 A1
(43) Pub. Date: Jan. 27, 2022

(54) SPLASH CONTROL BAND FOR NON-PNEUMATIC TIRE

(71) Applicant: Bridgestone Americas Tire Operations, LLC, Nashville, TN (US)

(72) Inventor: Louis J. Stark, Kronenwetter, WI (US)

(21) Appl. No.: 17/297,042

(22) PCT Filed: Dec. 12, 2019
(86) PCT No.: PCT/US19/65856

§ 371 Date: May 26, 2021

Related U.S. Application Data
(60) Provisional application No. 62/782,388, filed on Dec. 20, 2018.

(51) Int. Cl. B60C 7/14

(52) U.S. Cl. CPC B60C 7/14

(57) ABSTRACT

A non-pneumatic tire includes an annular inner ring, an annular outer ring, and a support structure extending from the annular inner ring to the annular outer ring. The support structure includes a plurality of spokes, webbing, cells, or other open-sided support structure. The tire includes a splash control band protruding from a side of the tire. The splash control band circumscribes a rotation axis of the tire and includes a surface facing the rotation axis. The surface can be continuous, angled, concave, and polygonal. The splash control band controls splashing of debris that accumulates within the support structure.

### FIELD OF INVENTION

The present disclosure relates to a band for a tire. More particularly, the present disclosure relates to a splash control band for a non-pneumatic tire, including a splash control tread band and a splash control web band.

### BACKGROUND

While various tire constructions enable a tire to run in an uninflated or underinflated condition, non-pneumatic tires do not require inflation. Rather, non-pneumatic tires include a plurality of spokes, webbing, cells, or other open-sided support structure that connects an inner ring to an outer ring. Some non-pneumatic tires include a tread mounted to the outer ring and a rim mounted to the inner ring.

Road dirt, water, snow, sand, mud, or other debris can accumulate on the open-sided support structure. As the non-pneumatic tire rotates, the accumulated debris may be projected or cast off the open-sided support structure, splashing on vehicles, pedestrians, operators, or other items within a splash zone of the tire. For example, non-pneumatic tires on all-terrain vehicles may cast off water or debris onto the exposed rider. Accordingly, splash control bands for controlling, reducing, eliminating, and preventing such splashing are needed.

### SUMMARY OF THE INVENTION

In one embodiment, a non-pneumatic includes an annular inner ring, an annular outer ring, and a support structure extending from the annular inner ring to the annular outer ring. The tire includes a tread disposed radially around the annular outer ring. A splash control band protrudes from a side of the tire and circumscribes a rotation axis of the tire. The splash control band includes a continuous surface facing the rotation axis.

In another embodiment, a non-pneumatic tire includes an annular inner ring, an annular outer ring, and a support structure extending from an outer surface of the annular inner ring to an inner surface of the annular outer ring. A tread is attached to an outer surface of the annular outer ring. A splash control band circumscribes a rotation axis of the tire. The splash control band includes a surface protruding from a side of the tire. The surface faces the rotation axis and has a profile selected from the group consisting of an angled surface, a concave surface, and a polygonal surface.

In yet another embodiment, a non-pneumatic tire an annular inner ring, an annular outer ring, and a support structure extending from the annular inner ring to the annular outer ring. A tread is radially disposed relative to the annular outer ring. The tire includes a splash control band protruding from a first side of the tire. The splash control band includes a surface facing a rotation axis of the tire and laterally circumscribing the rotation axis.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a front view of an undeformed non-pneumatic tire known in the prior art;

FIG. 2 is a front view of the non-pneumatic tire of FIG. 1 being deformed when subjected to a load;

FIG. 3 is a front view of a non-pneumatic tire known in the prior art showing debris accumulated in an interconnected web;

FIG. 4 is a front view of the non-pneumatic tire of FIG. 3 showing the accumulated debris splashing from the interconnected web;

FIG. 5 is a front view of an embodiment of a non-pneumatic tire including a splash control band for controlling splashing of debris from the interconnected web;

FIG. 6 is a partial cross-sectional view of the tire of FIG. 4 taken along line 6-6 of FIG. 4 showing debris splashing from the interconnected web;

FIG. 7 is a partial cross-sectional view of the tire of FIG. 5 taken along line 7-7 of FIG. 5 showing the splash control band controlling splashing of debris from the interconnected web;

FIG. 8 is partial cross-sectional view of a non-pneumatic tire including an embodiment of a splash control tread band;

FIG. 9 is partial cross-sectional view of a non-pneumatic tire including an embodiment of a splash control web band;

FIG. 10 is partial cross-sectional view of a non-pneumatic tire including an embodiment of a splash control band with a surface;

FIG. 11 is partial cross-sectional view of a non-pneumatic tire including an embodiment of a splash control band with an angled surface;

FIG. 12 is partial cross-sectional view of a non-pneumatic tire including an embodiment of a splash control band with a concave surface; and

FIG. 13 is partial cross-sectional view of a non-pneumatic tire including an embodiment of a splash control band with a polygonal surface.

### DETAILED DESCRIPTION

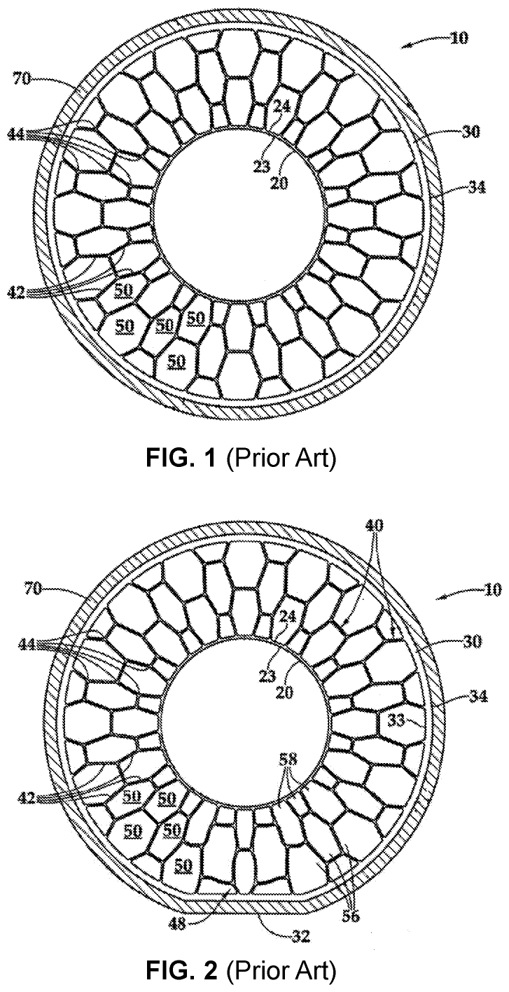

FIGS. 1 and 2 illustrate one embodiment of a non-pneumatic tire 10 known in the art. The non-pneumatic tire 10 is merely an exemplary illustration of a tire that may be used with one or more of a rim assembly, a tread, and a splash control band. It is not intended to be limiting.

In the illustrated embodiment, the non-pneumatic tire 10 includes a generally annular inner ring 20 that has an internal surface 23 and an external surface 24 and a generally annular outer ring 30 that has an internal surface 33 and an external surface 34. The generally annular inner ring 20 and the generally annular outer ring 30 can be made of cross-linked or uncross-linked polymers. In this disclosure, the term “polymer” means cross-linked or uncross-linked polymers.

The non-pneumatic tire 10 further includes an interconnected web 40 connects the generally annular inner ring 20 and the generally annular outer ring 30. The interconnected web 40 is a support structure extending radially from the outer surface 24 of the generally annular inner ring 20 to the inner surface 33 of the generally annular outer ring 30.

In the illustrated embodiment, the interconnected web 40 has at least two radially adjacent layers 56, 58 of web elements 42, 44 that define a plurality of generally polygonal openings 50. In alternative embodiments, a plurality of spokes or other open-celled support structure can connect the inner ring 20 to the outer ring 30.

In one embodiment, the generally annular inner ring 20 and the generally annular outer ring 30 are made of the same material as the interconnected web 40. The generally annular inner ring 20, the generally annular outer ring 30, and the interconnected web 40 can be made by injection or compression molding, castable polymer, additive manufacturing, or any other method generally known in the art and can be formed at the same time so that their attachment is formed by the material comprising the inner ring 20, the outer ring 30, and the interconnected web 40 cooling and setting.

The internal surface 23 of the generally annular inner ring 20 is configured to engage a rim assembly (not shown) to which the tire 10 is mounted. A tread layer 70 is attached to the outer surface 34 of the generally annular outer ring 30. Attachment can be done adhesively or using other methods commonly available in the art.

As shown in FIG. 2, the outer ring 30 can be configured to deform in an area 48 around and including a footprint region 32 of the tread layer 70, which decreases vibration and increases ride comfort of the tire 10.

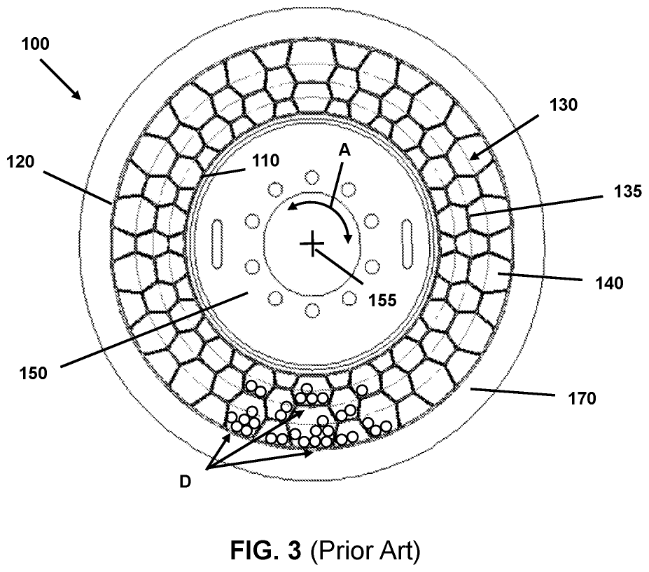

FIG. 3 illustrates a front view of an embodiment of a tire 100 known in the art having a generally annular inner ring 110, a generally annular outer ring 120, and an internal support structure in the form of a flexible, interconnected web 130 extending between the inner ring 110 and the outer ring 120. The flexible, interconnected web 130 is formed by a plurality of web elements 135 that define polygonal openings 140. In this particular embodiment, the web elements 135 form a plurality of hexagonal and substantially trapezoidal shapes, including an outer series of alternating hexagonal and trapezoidal opening and an inner series of alternating hexagonal and trapezoidal openings. It should be understood that the geometries shown in FIGS. 1-3 are merely exemplary and that any geometries may be employed. Similarly, spokes or other support structure may be employed instead of an interconnected web.

FIG. 3 additionally shows the tire 100 mounted on a rim assembly 150 at the generally annular inner ring 110. The rim assembly 150 may be rotated about rotation axis 155 (as shown by arrow A). Rotation can be imparted by an axle of a vehicle, or by other means to rotate the tire 100. A tread 170 is attached to the generally annular outer ring 120. The tread 170 can be manufactured from rubber or other elastomeric material.

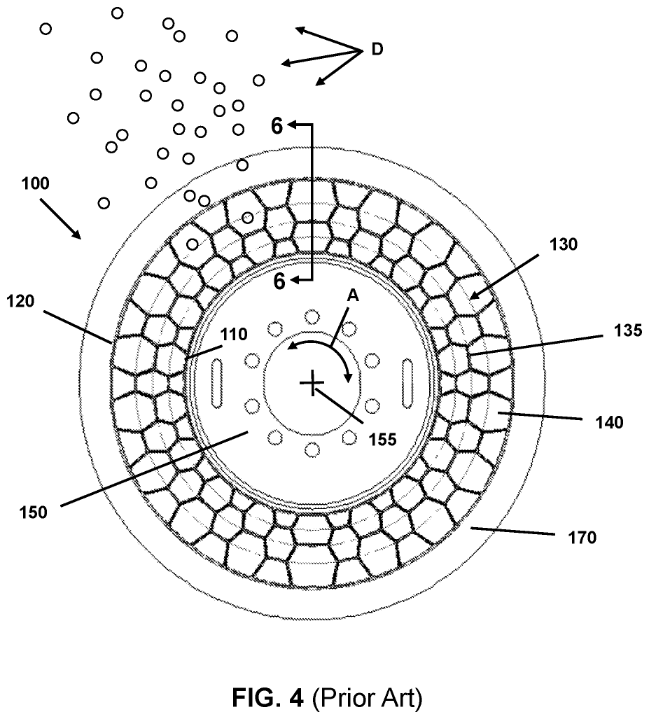

Because the interconnected web 130 is open-sided, road dirt, water, sand, mud, or other debris D can accumulate on or within the polygonal openings 140 of the plurality of web elements 135. As schematically illustrated in FIG. 4, when the tire 100 rotates about the rotation axis 155, the accumulated debris D may be projected or cast off the interconnected web 130. Accumulated debris D is generally cast off in a substantially radial direction. For example, when standing still, debris D can accumulate in the polygonal openings 140, and as the tire 100 begins to rotate, the debris D may splash on vehicles, pedestrians, operators, or other items within a splash zone of the tire 100. Likewise, when driving in wet or other adverse conditions, debris D can splash from the interconnected web 130 onto items within the splash zone of the tire 100.

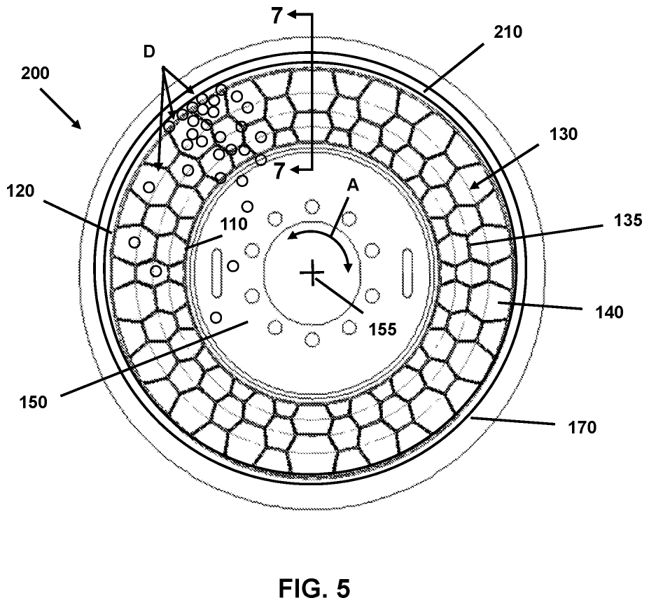

FIG. 5 shows an alternate embodiment of a tire 200. The tire 200 is substantially the same as the tire 100 of FIG. 4, except for the differences described herein. Like reference numerals are used for like components. The tire 200 includes a splash control band 210 for controlling, reducing, eliminating, and preventing splashing of debris D. The splash control band 210 is a circumferential protrusion that extends axially outward from the tire 200 and laterally circumscribes the rotation axis 155. As shown, the splash control band 210 is configured to control, reduce, eliminate, and prevent splashing of debris D. For example, the splash control band 210 can block and intercept the debris D as it is projected from the interconnected web 130. The splash control band 210 directs the debris D back toward the tire 200 or otherwise contains the debris D within a predetermined area around the tire 200 rather than splashing that would otherwise occur without a splash control band (See FIG. 4).

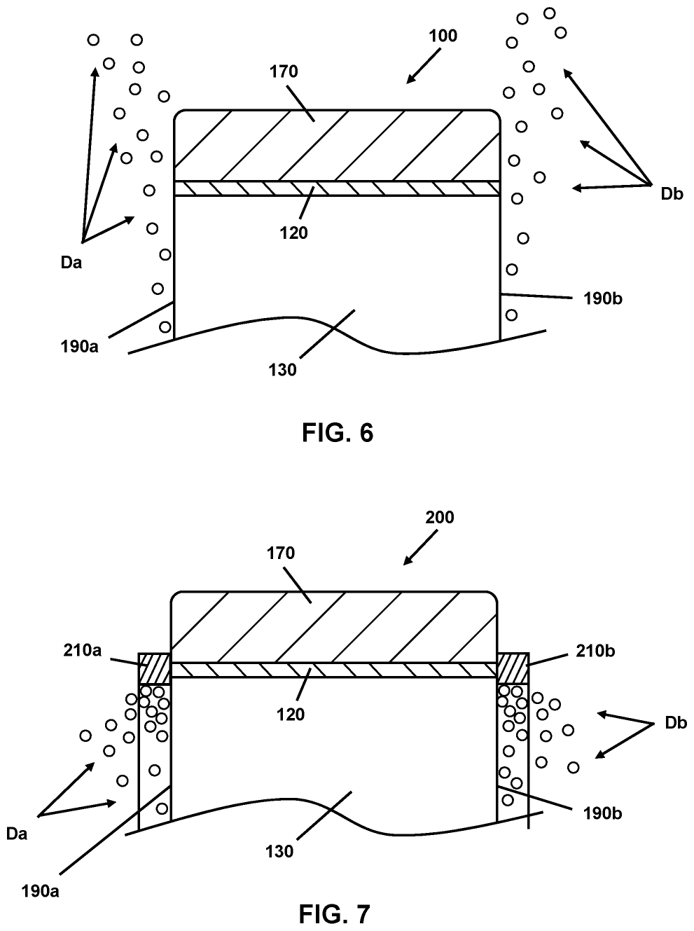

FIG. 6 shows a cross-sectional view of a portion of the tire 100 taken along line 6-6 of FIG. 4 with debris Da, Db respectively splashing from exterior and interior sides 190a, 190b of the interconnected web 130. FIG. 7 shows a cross-sectional view of a portion of the tire 200 including splash control bands 210a, 210b taken along line 7-7 of FIG. 5 with debris Da, Db splashing from exterior and interior sides 190a, 190b of the interconnected web 130 and being respectively contained by the splash control bands 210a, 210b.

The splash control bands 210a, 210b are hoop-shaped structures that include a radial outer surface and a radial inner surface that protrude from a side of the tire 200. The splash control bands 210a, 210b can be connected to the annular outer ring 120, interconnected web 130, and tread 170, but could also be connected to the tire 200 at different locations. In some embodiments, a single splash control band (e.g., splash control band 210a or splash control band 210b) can be provided on either of the exterior side 190a or the interior side 190b of the tire 200, or multiple splash control bands 210a, 210b can be provided on both sides 190a, 190b of the tire 200.

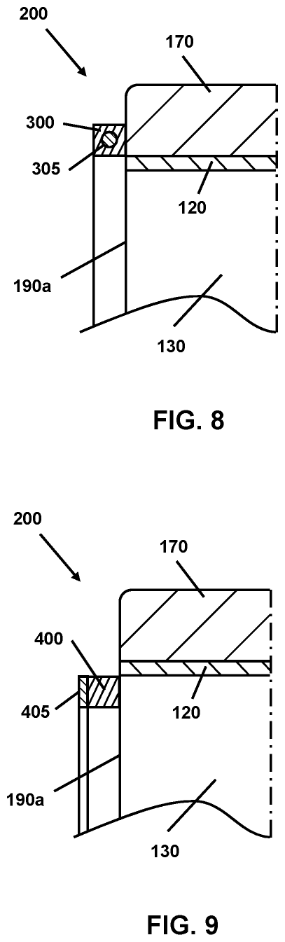

FIG. 8 shows a partial view of the tire 200 of FIG. 7 including an alternate embodiment of a splash control band 300 protruding from the tread 170 of the tire 200. For purposes of the disclosure, such a splash control band 300 may be referred to as a splash control tread band 300 because it protrudes from the tread 170. In some embodiments, all or a portion of the splash control tread band 300 may be formed as an integral part of the tread 170 or may be formed as a separate element attached to the sidewall of the tread 170. For example, the splash control tread band 300 can be attached to the tread 170 with an adhesive, welding, brazing, or a chemical bonding process, which may include heating, or other method of coupling.

FIG. 9 shows a partial view of the tire 200 of FIG. 7 including another alternate embodiment of a splash control band 400 protruding from the interconnected web 130 of the tire 200. For purposes of the disclosure, such a splash control band 400 may be referred to as a splash control web band 400 because it protrudes from the interconnected web 130. In some embodiments, all or a portion of the splash control web band 400 may be formed as an integral part of the interconnected web 130 or may be formed as a separate element attached to the interconnected web 130. For example, the splash control web band 400 can be attached to the interconnected web 130 with an adhesive, welding, brazing, or a chemical bonding process, which may include heating, or other method of coupling.

In further embodiments, the splash control band can protrude from both the tread 170 and the interconnected web 130 (e.g., a splash control tread/web band 210a, 210b, as shown in FIG. 7) and may be formed as an integral part of either or both of the tread 170 and the interconnected web 130 or may be formed as a separate element attached to the tread 170 and the interconnected web 130. The splash control band can also be connected to and protrude from the annular outer ring 120. Whether the splash control band is a splash control tread band 300 (FIG. 8), a splash control web band 400 (FIG. 9), or a splash control tread/web band 210a, 210b (FIG. 7), the splash control band extends axially outward along the rotation axis 155 past the side 190a of the interconnected web 130 to control splashing from the interconnected web 130.

The splash control band can be manufactured from a different material than the tread 170 and the interconnected web 130 or from the same material. For example, the splash control tread band 300 can be manufactured from the same rubber as the tread 170 or from stiffer or stronger rubber than the rubber of the tread 170 or a more pliable rubber than the tread 170. Similarly, the splash control web band 400 can be manufactured from the same material as the interconnected web 170 of from stiffer or stronger material or more pliable material than the material of the interconnected web 130. For example, stiffer or stronger material may better withstand contact with a curb or other surface while more pliable material may reduce scratching or abrasion of surfaces with which the material comes into contact.

Optionally, the splash control tread band 300 and the splash control web band 400 can include a stiffening element (e.g., wire, rod, plastic) extending along the splash control band 300, 400. The stiffening element can be manufactured from a material having a stiffness greater than the stiffness of one or more of the tread 170 and the interconnected web 130. In the illustrated embodiment of FIG. 8, stiffening element 305 is enclosed within the splash control tread band 300 to strengthen the splash control tread band 300. In the illustrated embodiment of FIG. 9, stiffening element 405 is attached to the outermost surface of the splash control web band 400 to strengthen the splash control web band 400 and define an outermost surface of the tire 200 for contacting a curb or other surface.

In further embodiments, the optional stiffening element 305, 405 can be partially enclosed within the splash control band 300, 400 and can be attached to one or more surfaces of the splash control band 300, 400. The stiffening elements laterally 305, 405 circumscribe the rotation axis 155 and extend along at least a portion or the entire circumference of the splash control band 300, 400 to strengthen the splash control band 300, 400 in the event the side of the tire 100 contacts a curb or other surface.

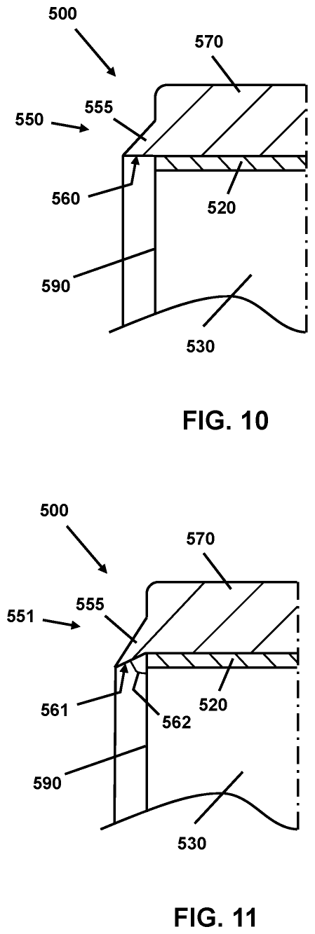

FIGS. 10-13 illustrate exemplary features of various splash control bands in accordance with embodiments of the disclosure. While the various splash control bands are shown with respect to a single side of a tire, a same or similar splash control band could be provided on the other side of the tire or on both sides of the tire without departing from the scope of the disclosure. Additionally, unless otherwise noted, one or more features of any one or more of the various splash control bands can be provided, either alone or in combination. The various splash control bands are shown without the optional stiffening element with the understanding that one or more stiffening elements may be provided in further embodiments. Moreover, the various splash control bands are described as splash control tread bands with the understanding that the features of the splash control tread bands may be applied in a same or similar manner to provide a splash control web band or a splash control tread/web band. The various splash control tread bands are illustrated as being manufactured from the same material as the tread with the understanding that all or a portion of the splash control tread band could be manufactured from one or more different materials.

An exemplary tire 500 having a tread 570, an interconnected web 530 with a side 590, and a generally annular outer ring 520 are illustrated for purposes of explanation of the various splash control bands of FIGS. 10-13. The tire 500, tread 570, interconnected web 530, side 590, and generally annular outer ring 520 are substantially similar to the tire 100, tread 170, interconnected web 130, side 190a, 190b, and generally annular outer ring 120 disclosed above. Features of the various splash control bands can include or be combine to include one or more features of the splash control band 210 of FIG. 5, splash control tread/web bands 210a, 201b of FIG. 7, splash control tread band 300 of FIG. 8, and splash control web band 400 of FIG. 9.

Referring to FIG. 10, the splash control band 550 includes a protrusion 555 extending axially outward away from the side 590 of the interconnected web 530. The protrusion 555 includes a surface 560 facing radially inward relative to the rotation axis of the tire 500. The surface 560 laterally circumscribes the rotation axis and extends circumferentially around the tread 570. The surface 560 extends perpendicular to the side 590 of the interconnected web 530 forming a continuous cylindrical surface 560 facing radially inward relative to the rotation axis of the tire 500. The axis of the cylindrical surface 560 may be coincident with the rotation axis of the tire 500. As described with respect to FIGS. 4-7, because the surface 560 faces radially inward relative to the rotation axis of the tire 500, debris splashing from the interconnected web 530 is contained and redirected back toward the rotation axis of the tire 500 rather than splashing onto items within a splash zone of the tire 500.

FIG. 11 illustrates another embodiment of a splash control band 551 with a protrusion 555 extending axially outward away from the side 590 of the interconnected web 530. The protrusion 555 includes an angled surface 561 facing radially inward relative to the rotation axis of the tire 500. The angled surface 561 laterally circumscribes the rotation axis and extends circumferentially around the tread 570. The angled surface 561 extends at an internal angle 562 relative to the side 590 of the interconnected web 530 forming a continuous frusto-conical surface 561 laterally circumscribing the rotation axis and facing radially inward relative to the rotation axis of the tire 500. The axis of the frusto-conical surface 561 may be coincident with the rotation axis of the tire 500. The angle 562 can vary in different embodiments. For example, the angle 562 can be less than 90 degrees and greater than zero degrees (e.g., 80-89 degrees, 70-79 degrees, 60-69 degrees, 50-59 degrees, 45 degrees, etc., including any ranges and subranges) such that the angled surface 561 faces radially inward relative to the rotation axis of the tire 500 to contain and redirect debris back toward the rotation axis of the tire 500.

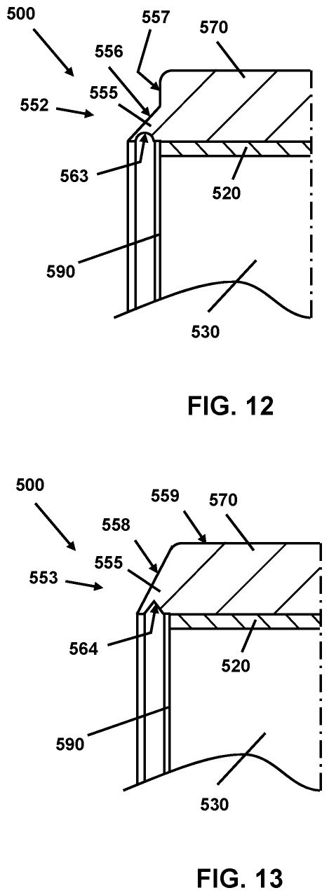

FIG. 12 illustrates another embodiment of a splash control band 552 with a protrusion 555 extending axially outward away from the side 590 of the interconnected web 530. The protrusion 555 includes a concave surface 563 facing radially inward relative to the rotation axis of the tire 500. The concave surface 563 laterally circumscribes the rotation axis and extends circumferentially around the tread 570. The concave surface 563 forms a continuous partial-toroidal surface 563 facing radially inward relative to the rotation axis of the tire 500. The axis of the partial-toroidal surface 563 may be coincident with the rotation axis of the tire 500. Although the concave surface 563 is illustrated as a generally semi-circular profile, other profiles defining a concave surface can be provided including, but not limited to, a partial-circular profile, a semi-elliptical profile, and a partial-elliptical profile, The concave surface 563 faces radially inward relative to the rotation axis of the tire 500 to contain and redirect debris back toward the rotation axis of the tire 500.

FIG. 13 illustrates another embodiment of a splash control band 553 with a protrusion 555 extending axially outward away from the side 590 of the interconnected web 530. The protrusion 555 includes a polygonal surface 563 facing radially inward relative to the rotation axis of the tire 500. The polygonal surface 563 laterally circumscribes the rotation axis and extends circumferentially around the tread 570. The polygonal surface 563 forms a continuous polygonal circumferentially extruded surface 563 facing radially inward relative to the rotation axis of the tire 500. The axis of the polygonal circumferentially extruded surface 563 may be coincident with the rotation axis of the tire 500. The polygonal surface 563 faces radially inward relative to the rotation axis of the tire 500 to contain and redirect debris back toward the rotation axis of the tire 500.

Comparing FIG. 12 and FIG. 13, the protrusion 555 of the splash control band 552 (FIG. 12) includes an outer surface 556 extending from a side 557 of the tread 570 in a direction toward the concave surface 563. On the other hand, the protrusion 555 of the splash control band 553 (FIG. 13) extends directly from a radially outer surface 559 of the tread 570 in a direction toward the polygonal surface 564. Although the outer surfaces 556, 558 are illustrated as linear surfaces, in further embodiments, either of the surfaces 556, 558 can be non-linear, curved, or include a plurality of surfaces forming the protrusion 555 as a variety of different geometries and shapes without departing from the scope of the disclosure. Accordingly, by providing a splash control band with features of the disclosure including a surface facing radially inward, debris splashing from the interconnected web 530 of the tire 500 is controlled, reduced, eliminated, and prevented.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A non-pneumatic tire comprising:
an annular inner ring;
an annular outer ring;
a support structure extending from the annular inner ring to the annular outer ring;
a tread disposed radially around the annular outer ring; and
a splash control band protruding from a side of the tire and circumscribing a rotation axis of the tire,
wherein the splash control band includes a continuous surface facing the rotation axis.

2. The non-pneumatic tire of claim 1, wherein the continuous surface defines a cylindrical surface having an axis coincident with the rotation axis.

3. The non-pneumatic tire of claim 1, wherein the continuous surface defines a frusto-conical surface having an axis coincident with the rotation axis.

4. The non-pneumatic tire of claim 1, wherein the continuous surface defines a partial-toroidal surface having an axis coincident with the rotation axis.

5. The non-pneumatic tire of claim 1, wherein the continuous surface defines a polygonal circumferentially extruded surface having an axis coincident with the rotation axis.

6. The non-pneumatic tire of claim 1, wherein the splash control band includes an outer surface extending from a side of the tread in a direction toward the continuous surface.

7. The non-pneumatic tire of claim 1, wherein the splash control band includes an outer surface extending from a radially outer surface of the tread in a direction toward the continuous surface.

8. The non-pneumatic tire of claim 1, wherein the splash control band extends from the support structure in a direction toward the continuous surface.

9-15. (canceled)

16. A non-pneumatic tire comprising:
an annular inner ring;
an annular outer ring;
a support structure extending from an outer surface of the annular inner ring to an inner surface and the annular outer ring;
a tread attached to an outer surface of the annular outer ring; and
a splash control band circumscribing a rotation axis of the tire, wherein the splash control band includes a surface protruding from a side of the tire, wherein the surface faces the rotation axis and includes a profile selected from the group consisting of an angled surface, a concave surface, and a polygonal surface.

17. The non-pneumatic tire of claim 16, wherein the splash control band includes a stiffening element enclosed within the splash control band.

18. The non-pneumatic tire of claim 16, wherein the splash control band includes a stiffening element attached to an axially outer surface of the splash control band.

19. The non-pneumatic tire of claim 16, wherein the surface is continuous and circumscribes the rotation axis.

20. The non-pneumatic tire of claim 16, wherein the support structure includes an interconnected web having a plurality of web elements defining an open-celled structure.

21. A non-pneumatic tire comprising:
an annular inner ring;
an annular outer ring;
a support structure extending from the annular inner ring to the annular outer ring;
a tread radially disposed relative to the annular outer ring; and
a first splash control band protruding from a first side of the tire; wherein
the first splash control band includes a first surface facing a rotation axis of the tire and laterally circumscribing the rotation axis.

22. The non-pneumatic tire of claim 21, further comprising a second splash control band protruding from a second side of the tire, wherein the second splash control band includes a second surface facing the rotation axis of the tire and laterally circumscribing the rotation axis.

23. The non-pneumatic tire of claim 22, wherein at least one of the first surface and the second surface defines a cylindrical surface.

24. The non-pneumatic tire of claim 22, wherein at least one of the first surface and the second surface defines a frusto-conical surface.

25. The non-pneumatic tire of claim 22, wherein at least one of the first surface and the second surface defines a partial-toroidal surface.

26. The non-pneumatic tire of claim 22, wherein at least one of the first surface and the second surface defines a polygonal circumferentially extruded surface.

27. The non-pneumatic tire of claim 22, wherein at least one of the first surface and the second surface is continuous and entirely laterally circumscribes the rotation axis.
